(19) United States
(12) Patent Application Publication
(10) Pub. No.: US 2012/0192811 A1
(43) Pub. Date: Aug. 2, 2012

(54) Over The Head Prong Collar

(75) Inventor: Stephen Neil Robinson, Ortonville, MI (US)

(73) Assignee: COMMON SCENTS CANINE CENTER, INC., Ortonville, MI (US)

(21) Appl. No.: 13/222,197

(22) Filed: Aug. 31, 2011

Related U.S. Application Data
(60) Provisional application No. 61/437,464, filed on Jan. 28, 2011.

(51) Int. Cl. A01K 27/00

(52) U.S. Cl. 119/862

(57) ABSTRACT

A collar for use in training animals, such as a prong collar, is provided that includes an attachment ring affixed to one end of a pull chain and a clasp at least indirectly attached to an opposite end of the pull chain. The collar may also include a neck portion having a pair of joining links affixed at opposite ends of the neck portion. The pull chain may be threaded through apertures in the joining links to form a closed loop with the neck portion. The attachment ring and the clasp may be dimensioned larger than the apertures to prevent the pull chain from disconnecting with the neck portion, thereby maintaining the closed loop. Once placed over the head of the pet, the collar may be secured with the proper fit by connecting the clasp to the attachment ring.

### CROSS-REFERENCE TO RELATED APPLICATIONS

This application claims the benefit of U.S. provisional Application No. 61/437,464 filed Jan. 28, 2011, the disclosure of which is incorporated in its entirety by reference herein.

### TECHNICAL FIELD

The present application relates to a collar for use in training animals and, in particular, to a prong collar that can fit over the head of a pet when placing around its neck.

### SUMMARY

Broadly, one or more embodiments of the present application generally provide a prong collar, comprising a neck portion, a pull chain, an attachment ring attached to one end of the pull chain, a clasp attached to an opposite end of the pull chain for interconnecting with the attachment ring, and first and second joining links attached to opposite ends of the neck portion for retaining portions of the pull chain. The one or more embodiments of the present application provide a collar for use in pet training that increases the ease of placing the collar on a pet when in an open configuration, and increases the ease of securing the collar, correctly fitted with a proper number of interconnecting links, in a closed configuration once the collar is placed on the pet.

### BRIEF DESCRIPTION OF THE DRAWINGS

FIG. 1 is an exemplary view of a collar in an open configuration in accordance with one or more embodiments of the present application;

FIG. 2 is an exemplary view of the collar of FIG. 1 in a closed configuration;

FIG. 3a is exemplary, close-up view of a clasp for use with a collar in accordance with one or more embodiments of the present application;

FIG. 3b is another exemplary, close-up view of an alternative clasp for use with a collar in accordance with one or more embodiments of the present application; and

FIG. 3c is yet another exemplary, close-up view of an alternative clasp for use with a collar in accordance with one or more embodiments of the present application.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

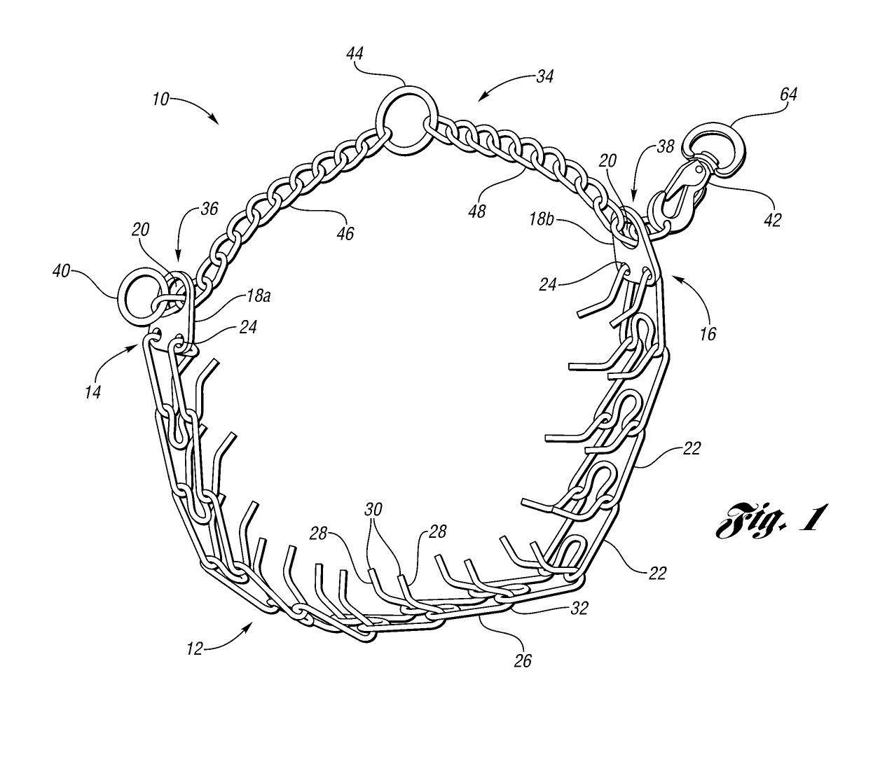

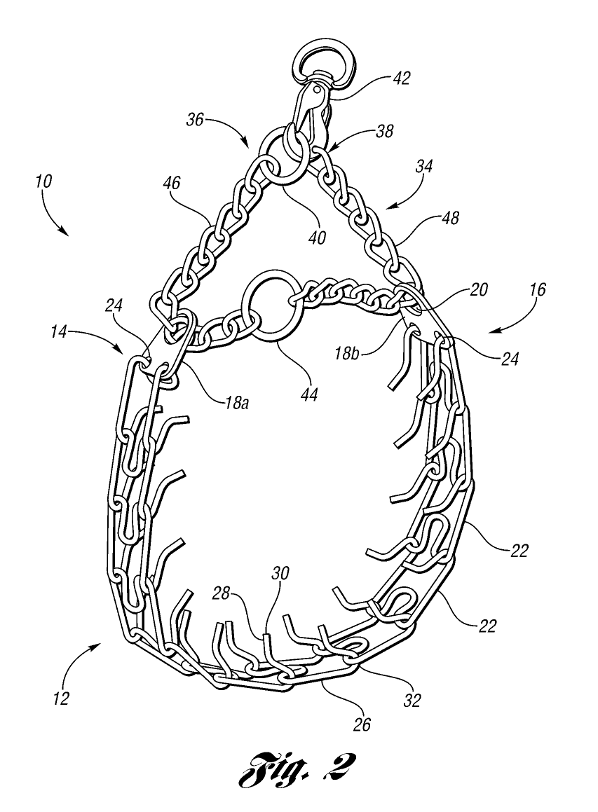

With reference to the Figures, like references refer to like elements in the several drawings. FIGS. 1 and 2 illustrate a collar 10 shown in an open configuration and a closed configuration, respectively, according to one or more embodiments of the present application. The collar 10 may be a prong collar and may be placed over the head and around the neck of an animal, such as a pet dog, for training purposes. As seen therein, the collar 10 may include a neck portion 12 having a first end 14 and a second end 16. A first joining link 18a may be located at the first end 14 and a second joining link 18b may be located at the second end 16. According to one or more embodiments, the first and second joining links 18a,b may be stamped plates having at least one aperture 20. In another embodiment, the first and second joining links 18a,b may be a formed wire. The first and second joining links 18a,b may be configured to interconnect to a plurality of interconnecting links 22. Accordingly, the plurality of interconnecting links 22 may be interposed between the first joining link 18a and the second joining link 18b to form a chain. The first and second joining links 18a,b may each further include a pair of eyes 24 for connecting to an interconnecting link 22.

According to one or more embodiments of the present application, each interconnecting link 22 may consist of a base member 26, which may be located in one plane and is generally shaped like a W, and a pair of arms 28, which may be provided with generally rounded or blunted free ends 30. The arms 28 may protrude from the base plane to extend inwardly along an arm plane that may be oriented at an angle of approximately 35 to 90 degrees relative to the base plane. Thereby, the arms 28 may be bent inwardly in such a manner that U-shaped hook regions 32 may be formed that act like hooks for connecting one interconnecting link 22 to another.

The collar 10 may further include a pull chain 34 having a third end 36 and a fourth end 38. The pull chain 34 may be composed of a plurality of links or elements that may be joined or interconnected together to form the pull chain 34. Alternatively, the pull chain 34 may comprise a cord or webbing. As shown in FIGS. 1 and 2, the pull chain 34 may be threaded through each of the first and second joining links 18a,b. For example, the third end 36 may be threaded through the aperture 20 in the first joining link 18a and the fourth end 38 may be threaded through the aperture 20 in the second joining link 18b. An attachment ring 40 may be affixed to the third end 36 of the pull chain 34. The attachment ring 40 may be sized larger than the aperture 20 in the first joining link 18a, thereby preventing it from passing therethrough. For instance, the attachment ring 40 may have an outer diameter that is greater than the inner diameter of the aperture 20.

According to one or more embodiments, a clasp 42 may be connected to the fourth end 38 of the pull chain 34, as will be described in greater detail below. Like the attachment ring 40, the clasp 42 may be sized generally larger than the aperture 20 of the second joining link 18b to prevent it from passing therethrough. As shown in FIG. 1, the attachment ring 40 and the clasp 42 may prevent the pull chain 34 from disconnecting with the neck portion 12 when the collar 10 is in the open configuration. The collar 10 may be considered to be in the open configuration when the attachment ring 40 is disconnected from the clasp 42. In this regard, the attachment ring 40 and the first joining link 18a may retain the third end 36 of the pull chain 34 from disconnecting with the first end 14 of the neck portion 12. Similarly, the clasp 42 and the second joining link 18b may retain the fourth end 38 of the pull chain 34 from disconnecting with the second end 16 of the neck portion 12. Accordingly, in the open configuration, the first and second joining links 18a,b may be capable of being separated by about a full length of the pull chain 34, which may allow a greater overall circumference of the collar 10 than when in the closed configuration. As illustrated in FIG. 2, the collar 10 may be considered to be in the closed configuration when the attachment ring 40 is secured or otherwise retained by the clasp 42.

According to one or more embodiments, the pull chain 34 may include a limit ring 44 that may interrupt the plurality of links. As show in FIG. 1, the limit ring 44 may be centrally disposed in the pull chain 34 approximately midway between the third end 36 and the fourth end 38. The limit ring 44 may define a first chain section 46 between the third end 36 and the limit ring 44 and a second chain section 48 between the fourth end 38 and the limit ring 44. Similar to the attachment ring 40 and the clasp 42, the limit ring 44 may be sized larger than the apertures 20 formed in the first and second joining links 18a,b, thereby preventing it from passing therethrough. Accordingly, the first joining link 18a may be retained on the first chain section 46 by the attachment ring 40 and the limit ring 44 and may be movable therebetween. Moreover, the second joining link 18b may be retained on the second chain section 48 by the limit ring 44 and the clasp 42 and may be movable therebetween. The limit ring 44 may limit the amount the collar 10 may be closed, when in the closed configuration of FIG. 2, thus preventing choking of the pet by the collar 10.

With reference to FIG. 2, in the closed configuration, the attachment ring 40 may be secured by the clasp 42, as previously described. Connecting the attachment ring 40 to the clasp 42 may draw the first and second ends 14, 16 of the neck portion 12 together reducing the overall circumference of the collar 10. By using an appropriate number of interconnecting links 22 to form the neck portion 12, a correct fit around the neck of an animal may be produced when the attachment ring 40 is secured by the clasp 42 in the closed configuration.

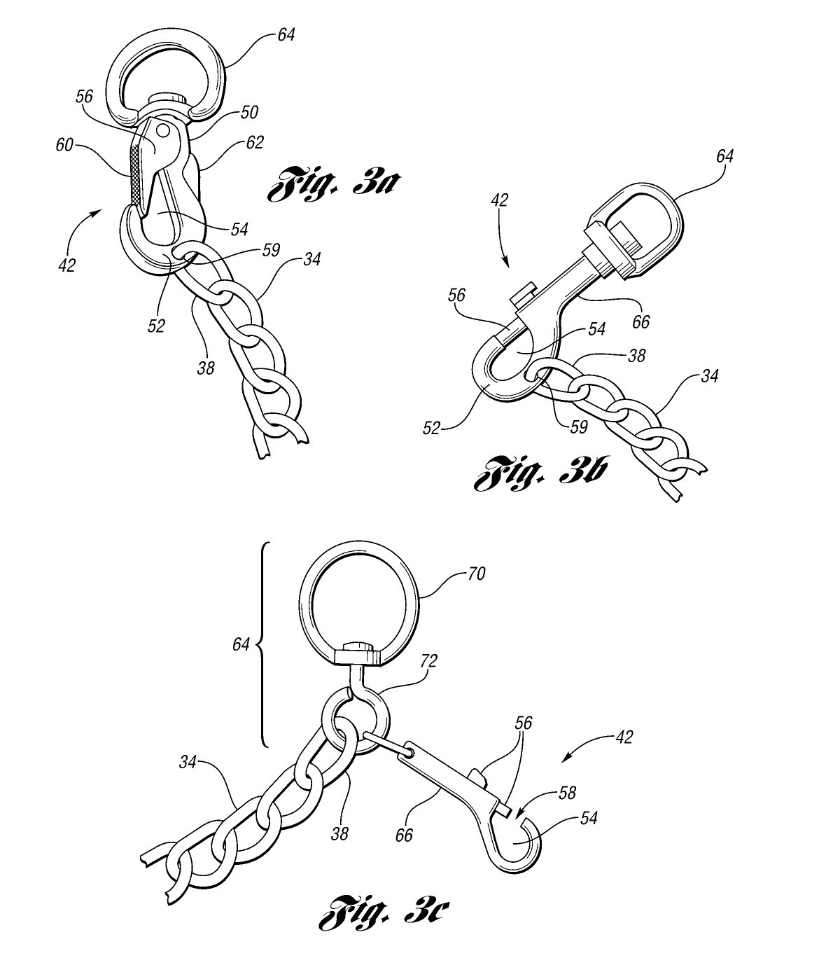

Referring to FIGS. 3a-b, various exemplary embodiments of a clasp 42 that may be employed in accordance with one or more exemplary embodiments of the present application are illustrated. For example, the clasp 42 may be a spring clip-type clasp such as those shown in FIGS. 3a-c, though other types of clasps not shown may also be employed without departing from the scope of the present application. With specific reference to FIG. 3a, the clasp 42 may be a boat snap 50. The clasp 42 may form a loop 52 defining a cavity 54. The loop 52 may include a gate 56, which may be a spring-loaded element capable of being selectively opened and closed. The gate 56 may provide an opening 58 (shown in FIG. 3c) to the cavity 54 enabling the clasp 42 to engage or interconnect with the attachment ring 40 for selectively securing the attachment ring 40 to the clasp 42. Although shown as a spring-loaded element, the gate 56 may be a rotating or other type of locking element. As previously described, the fourth end 38 of the pull chain 34 may also be attached or otherwise connected to the clasp 42. According to one or more embodiments, the fourth end 38 of the pull chain 34 may be permanently affixed to the clasp through a hole 59.

The clasp 42 may include a finger grip 60 disposed on the gate 56 and may also have a gripping plate 62 disposed on a side of the loop 52 opposite the gate 56. The finger grip 60 and the gripping plate 62 may facilitate use of the clasp 42 by providing tactile feedback to a user through a gripping surface. The gripping plate 62 may be, for example, a tab or protrusion configured to be grasped or gripped by a user. The gripping plate 62 and the finger grip 60 may have a surface comprising a textured, cross-hatched, knurled, rubberized, or coated surface.

The clasp 42 may include or otherwise be attached to a connecting ring 64. The connecting ring 64 may be used to connect a leash (not shown). According to one or more embodiments, the connecting ring 64 may be a swivel ring, which may be, for example, a circular or “D” shaped ring capable of swiveling or rotating independently of the clasp 42. The connecting ring 64 may also be integrated into the clasp 42 in a fixed position.

FIGS. 3b and 3c illustrate alternative clasps and connecting ring configurations. As shown in FIGS. 3b and 3c, the clasp 42 may be a snap fastener 66. As shown in FIG. 3c, the connecting ring 64 may be a swivel ring having a first swivel ring portion 70 and a second swivel ring portion 72. The first swivel ring portion 70 may be freely rotatable with respect to the second swivel ring portion 72. A leash (not shown) may be attached or connected to the first swivel ring portion 70, while the clasp 42 may be attached or linked to the second swivel ring portion 72. According to one or more embodiments of the present application, the fourth end 38 of the pull chain 34 may be directly connected to the connecting ring 64. For instance, the fourth end 38 may be linked to the second swivel ring portion 72 along with the clasp 42, thereby connecting the fourth end 38 of the pull chain 34 to the clasp 42 at least indirectly.

According to one or more embodiments of the present application, elements of the collar 10 may be formed from wire, stamped or forged metal components, extruded polymer, molded or formed materials, or woven materials. Aspects of the foregoing elements may include joints that may be coalescently welded, ultrasonically welded, crimped, riveted, and adhered.

In one or more exemplary embodiments, the foregoing components may be formed from plastic, polymer, stainless steel, or a metal alloy, and may be painted, plated, or powder coated. The plurality of interconnecting links 22, the first and second joining links 18a,b, and the pull chain 34 may be formed from wire, plastic, or polymer and may having a diameter ranging from about one (1.0) millimeter to about four (4.0) millimeters.

As previously described, the collar 10 may be a prong collar for use in pet training that reduces or eliminates the difficulty associated with applying conventional prong collars to pets. In the open configuration, the collar 10 can be expanded to create an opening sufficiently large enough to place over a pet's head while the attachment ring 40 maintains the collar 10 in a closed loop. Specifically, the attachment ring 40 can prevent the third end 36 of the pull chain 34 from passing completely through the aperture 20 in the first joining link 18a and separating from the first end 14 of the neck portion 12. Maintaining the link between the pull chain 34 and the neck portion 12, even in the open configuration, may increase the ease of placing the collar 10 over a pet's head and around its neck. Once around a pet's neck, the attachment ring 40 may facilitate a relatively easy connection to the clasp 42 to connect the third and fourth ends 36, 38 of the pull chain 34 together to reduce the size of the collar 10, correctly fitted with the proper number of interconnecting links 22, in the closed configuration.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A collar for an animal comprising:
a neck portion including a first joining link disposed at a first end and a second joining link disposed at a second end, each of the first and second joining links having an aperture;
a pull chain having a third end and a fourth end, the pull chain threaded through each aperture of the first and second joining links;
an attachment ring affixed to the third end of the pull chain and sized larger than the aperture of the first joining link to retain the third end of the pull chain from disengagement with the first end of the neck portion when the collar is in an open configuration; and
a clasp attached to the fourth end of the pull chain and sized larger than the aperture of the second joining link to retain the fourth end of the pull chain from disconnecting with the second end of the neck portion when the collar is in the open configuration,
wherein the clasp selectively secures the attachment ring to link the third end of the pull chain to the fourth end of the pull chain when the collar is in a closed configuration.

2. The collar of claim 1, wherein the neck portion includes a plurality of interconnecting links interposed between the first joining link and the second joining link.

3. The collar of claim 2, wherein the interconnecting links each include a pair of arms having free ends projecting generally inwardly.

4. The collar of claim 1, wherein the first and second joining links further include a pair of eyes for connecting to the interconnecting links.

5. The collar of claim 4, wherein the first and second joining links are formed from stamped plates.

6. The collar of claim 4, wherein the first and second joining links are formed from bent wire.

7. The collar of claim 1, further comprising a limit ring centrally disposed in the pull chain approximately midway between the third end and the fourth end,
wherein the limit ring is sized larger than the apertures of the first and second joining links such that the first joining link is secured to the pull chain between the attachment ring and the limit ring and the second joining link is secured to the pull chain between the limit ring and the clasp.

8. The collar of claim 1, further comprising a connecting ring affixed to the clasp.

9. The collar of claim 8, wherein the connecting ring is a swivel ring and the connecting ring is freely rotatable with respect to the clasp.

10. The collar of claim 1, wherein the clasp is a spring clip.

11. The collar of claim 10, wherein the clasp is a boat snap.

12. A collar for an animal comprising:
a neck portion including a first joining link disposed at a first end and a second joining link disposed at a second end, each of the first and second joining links having an aperture;
a pull chain having a third end and a fourth end, the pull chain threaded through each aperture of the first and second joining links;
an attachment ring affixed to the third end of the pull chain and sized larger than the aperture of the first joining link to retain the third end of the pull chain from disconnecting with the first end of the neck portion when the collar is in an open configuration;
a connecting ring connected to the fourth end of the pull chain; and
a clasp, connected to the connecting ring, that selectively secures the attachment ring to link the third end of the pull chain to the fourth end of the pull chain when the collar is in a closed configuration.

13. The collar of claim 12, wherein the connecting ring is a swivel ring and the connecting ring is freely rotatable with respect to the clasp and the fourth end of the pull chain.

14. The collar of claim 13, wherein the swivel ring comprises a first swivel ring portion freely rotatable with respect to a second swivel ring portion.

15. The collar of claim 12, wherein the neck portion includes a plurality of interconnecting links interposed between the first joining link and the second joining link.

16. The collar of claim 15, wherein the interconnecting links each include a pair of arms having free ends projecting generally inwardly.

17. The collar of claim 12, further comprising a limit ring centrally disposed in the pull chain approximately midway between the third end and the fourth end,
wherein the limit ring is sized larger than the apertures of the first and second joining links such that the first joining link is secured to the pull chain between the attachment ring and the limit ring and the second joining link is secured to the pull chain between the limit ring and the connecting ring.

18. The collar of claim 12, wherein the clasp includes a loop defining a cavity, the loop including a gate that can be selectively opened to provide an opening to the cavity for selectively securing the attachment ring.

19. A collar for an animal comprising:
a neck portion having a first end and a second end, the neck portion including a first joining link disposed at the first end, a second joining link disposed at the second end, and a plurality of interconnecting links interposed between the first joining link and the second joining link, each of the first and second joining links having an aperture;
a pull chain having a third end and a fourth end and a centrally disposed limit ring defining a first chain section and a second chain section, the first chain section threaded through the aperture of the first joining link and the second chain section threaded through the aperture of the second joining link, the limit ring sized larger than either aperture such that it is prevented from passing therethrough;
an attachment ring affixed to the third end of the pull chain and sized larger than the aperture of the first joining link to retain the first chain section threaded through the aperture of the first joining link when the collar is in an open configuration;
a clasp at least indirectly connected to the fourth end of the pull chain, the clasp selectively securing the attachment ring to link the third end of the pull chain to the fourth end of the pull chain when the collar is in a closed configuration; and
a swivel ring rotatably connected to the clasp.

20. The collar of claim 20, wherein the clasp is permanently affixed to the fourth end of the pull chain and sized larger than the aperture of the second joining link, the clasp further including a loop defining a cavity, the loop including a gate that can be selectively opened to provide an opening to the cavity for selectively securing the attachment ring.
